(19) United States
(12) Patent Application Publication
(10) Pub. No.: US 2026/0338234 A1
(43) Pub. Date: Oct. 29, 2026

(54) ELECTRIC BALANCE RING, AND ROLLING BEARING COMPRISING SUCH A RING

(71) Applicant: HUTCHINSON, Paris (FR)

(72) Inventors: Sébastien CHABAL, LE LION D'ANGERS (FR); Christophe MOLLE, LE CELLIER (FR); Patrick BELTRAMI, LIVRÉ LA TOUCHE (FR)

(21) Appl. No.: 19/110,139

(22) PCT Filed: Oct. 20, 2022
(86) PCT No.: PCT/FR2022/051989

§ 371 Date: Mar. 10, 2025

(51) Int. Cl. F16C 41/00; H02K 11/40

(52) U.S. Cl. CPC F16C 41/002; H02K 11/40

(57) ABSTRACT

Grounding ring (10), also referred to as an electric balance ring, intended to be mounted between a fixed element (11) and a rotating element (12), comprising a first frame (20), a membrane (30), and a second frame (40), the first frame and the membrane being capable of conducting an electric current. The membrane comprises a wear zone (ZU) at a second end, the wear zone being thicker than the body of the membrane.

### TECHNICAL FIELD

The present invention relates to a grounding ring, also referred to as an electric balance ring, used to transmit electrical charges or an electric current between a fixed element and a rotating element that is rotatable relative to the fixed element about an axis of rotation. Typically, the ring is used to conduct electrical charges between a housing and a shaft of a machine, or more particularly between a stator and a rotor of an electric machine.

### PRIOR ART

The invention thus relates to a grounding ring comprising:
a first frame that is annular and rigid, securely mounted to one among the fixed element and the rotating element,
a membrane that is annular and is made of an elastic material, extending between a first end in contact with the first frame and a second end in contact with the other among the fixed element and the rotating element, said membrane having a body between the first end and the second end,
a second frame that is annular and rigid, securely mounted to the first frame and adapted to clamp and fix the membrane between the first frame and the second frame, and wherein
the first frame and the membrane are capable of conducting an electric current between the fixed element and the rotating element.

Document US 2020/0295634 shows such a grounding ring. However, that ring has wear issues in its membrane, which alters the electrical conduction over time and therefore the performance of the product. In some alternative embodiments, a plurality of membranes is installed in parallel in an attempt to compensate for this disadvantage, but at the cost of some complexity.

### STATEMENT OF THE INVENTION

A first object of the present invention is to provide a grounding ring that is durable, meaning its electrical conduction varies little over time.

To this end, the membrane of the grounding ring comprises a wear zone at the second end, said wear zone being thicker than the body of the membrane, and the wear zone forming a contact surface configured to slide on a sliding surface of the other element while in contact therewith and to provide high electrical conductivity between the fixed element and the rotating element.

By means of these arrangements, the wear zone, which undergoes wear during operation, has a contact surface that maintains a substantially constant surface area. Thus, the electrical conductivity of the ring remains constant.

In various embodiments of this product, one or more of the following arrangements may optionally also be used.

According to one aspect, the wear zone of the membrane extends in the direction of the axis of rotation for a length that is greater than or equal to the thickness of the body of the membrane, the ring being in the mounted position between the fixed element and the rotating element.

According to one aspect, the wear zone has a greater thickness than the thickness of the body of the membrane.

According to one aspect, the wear zone has a mass that is configured to ensure contact between the contact surface and the sliding surface over a range of rotational speeds of the rotating element.

According to one aspect, the membrane is fixed to the second frame.

According to one aspect, the membrane comprises radial slots extending to the second frame and ending in an open portion.

According to one aspect, the membrane comprises an electrically conductive coating, said coating being at least on the contact surface of the wear zone.

According to one aspect, the membrane is formed from a PTFE material containing a conductive filler, such as carbon.

According to one aspect, the second frame is capable of conducting an electric current between the fixed element and the rotating element.

According to one aspect, the second frame has a radial height that is greater than a radial height of the first frame.

According to one aspect, the radial height of the second frame is at least twice the radial height of the first frame, and the radial height of the first frame is less than half the distance between the fixed element and the rotating element.

According to one aspect, the first frame and/or the second frame comprise pins adapted to penetrate the membrane and secure the membrane to the first and/or second frame.

According to one aspect, the second frame has an internal end that is curved towards the second end of the membrane, when the ring is in the mounted position.

A second object of the present invention is to provide a rolling bearing comprising a grounding ring according to the above characteristics, and rolling bodies arranged within a rolling space to allow the relative rotation of the rotating element with respect to the fixed element, about the axis of rotation.

### BRIEF DESCRIPTION OF DRAWINGS

Other features and advantages of the product will become apparent during the following description of at least one of its embodiments, given as a non-limiting example, with reference to the attached drawings.

In the drawings:

FIG. 1 is a section view of a grounding ring according to the present disclosure;

FIG. 2 is a view identical to FIG. 1, showing dimensions of the ring elements;

FIG. 3 is a partial front view showing a variant of the ring of FIG. 1 comprising radial slots;

FIG. 4A, FIG. 4B, FIG. 4C and FIG. 4D show variant shapes of the wear zone of a ring of the type shown in FIG. 1;

FIG. 5 is a section view of a grounding ring of the type shown in FIG. 1, further comprising a sealing member; and

FIG. 6 is a section view of a rolling bearing incorporating a grounding ring of the type shown in FIG. 1.

In the various figures, the same numerical references designate identical or similar elements.

### DETAILED DESCRIPTION

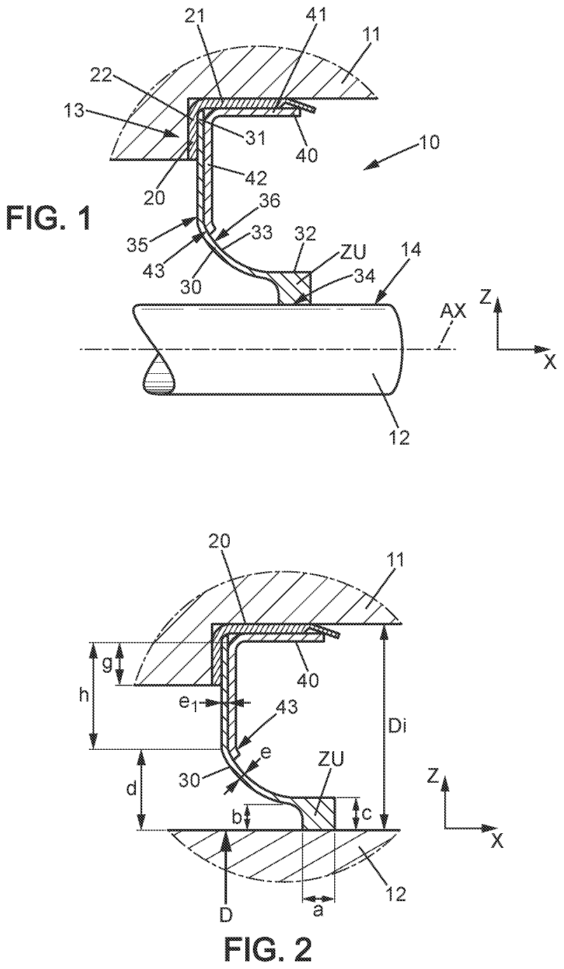

FIG. 1 shows an embodiment of a grounding ring 10 which is intended to be mounted between a fixed element 11 and a rotating element 12 that is rotatable relative to the fixed element about an axis of rotation AX. Ring 10 comprises:
a rigid first frame 20, of the type that is annular around the axis of rotation, and securely mounted to one among fixed element 11 and rotating element 12,
a membrane 30, also of the type that is annular around the axis of rotation, made of an elastic material, and
a rigid second frame 40, also of the type that is annular around the axis of rotation, and securely mounted to first frame 30.

First frame 20 and membrane 30 are capable of conducting an electric current, in particular so that electric current can flow between fixed element 11 and rotating element 12, or vice versa.

Membrane 30 extends between a first end 31 in contact with first frame 20, and a second end 32 in contact with the other element among the fixed element and the rotating element. Membrane 30 comprises a body 33 between first end 31 and second end 32.

In particular, fixed element 11 may be an external element, i.e. the furthest from axis of rotation AX, i.e. positioned around rotating element 12 which is then an internal element. This is the case when rotating element 12 is a rotating shaft (FIG. 1).

Conversely, fixed element 11 may be an internal element, i.e. closest to axis of rotation AX, i.e. positioned inside the rotating element which is then an external element.

To simplify the present description, we will now consider first frame 20 as being connected to external fixed element 11, and that second end 32 is in contact with the other element, i.e. internal rotating element 12, but of course the other configuration is also suitable in the present disclosure.

Second frame 40 is adapted to clamp and fix membrane 30 between first frame 20 and second frame 40. In other words, membrane 30 is fixed by clamping between the first frame and the second frame, for example at the time when second frame 40 is fixed to first frame 20.

According to the present disclosure, membrane 30 comprises a wear zone ZU at second end 32 of said membrane 30. Wear zone ZU is thicker than body 33 of membrane 30. In FIG. 2, the thickness of body 33 of the membrane is denoted (e), this thickness being measured in a direction substantially perpendicular to the core of the body of membrane 30. The thickness of wear zone ZU of membrane 30 is denoted (b), this thickness being measured in a direction perpendicular to axis of rotation AX, in the mounted position of ring on rotating element 12.

Furthermore, membrane 30 may have a non-constant thickness. Thus, the thickness of the membrane at first end 31, denoted (e1), may be greater than the thickness (e) of body 33 of membrane 30.

Wear zone ZU thus forms a contact surface 34 that is configured to slide on a sliding surface 14 of the other element, i.e. rotating element 12 of FIG. 1, while in contact therewith.

Grounding ring 10 can therefore conduct an electric current from n rotating element 12 to membrane 30 via the contact of contact surface 34 of wear zone ZU at second end 32 of membrane 30, then via body 33 of membrane 30 to first frame 20 in contact with first end 31 of membrane 30, then via first frame 20 to fixed element 11 by means of the contact between first frame 20 and fixed element 11. The electrical conduction may also take the reverse path. Grounding ring 10 thus has high electrical conductivity, enabling electrical charges to be discharged efficiently.

During the operation of ring 10, the sliding and possibly the friction of contact surface 34 of membrane 3 on sliding surface 14 causes wear to this contact surface and wear to wear zone ZU which reduces its thickness. However, the thickness of wear zone ZU, which is thicker than body 33 of membrane 30, makes it possible to maintain a substantially constant surface area of contact surface 34, as long as wear zone ZU is not completely worn down: as long as its thickness is not tending towards zero. Thus, by means of contact surface 34 of wear zone ZU, the electrical conductivity of the ring can remain constant over a very long operating period.

In the mounted position in FIG. 1 and FIG. 2, wear zone ZU of membrane 30 extends over a length (a) in the direction of axis of rotation AX. For example, length (a) is greater than or equal to thickness (e) of body 33 of membrane 30:

a>=e.

Advantageously, length (a) is greater than 1 mm, and may be greater than 2 mm. Thus, contact surface 34 has a surface area S₃₄ of:

A₃₄=π·D·a

Where D is the diameter of rotating element 12, and
a is the length of wear zone ZU.

Optionally, length (a) is greater than or equal to thickness (e1) of first end 31 of membrane 30:

a>=e1.

Due to this length (a) of wear zone ZU, ring 10 has high electrical conductivity. By increasing length (a), this electrical conductivity can be increased.

Wear zone ZU also has a thickness (b), this thickness (b) being measured in a direction perpendicular to the direction of axis of rotation AX, in the mounted position. Advantageously, thickness (b) is greater than thickness (e) of body 33 of membrane 30, and preferably more than twice the thickness (e) of body 33 of membrane 30. The wear zone is thus sufficiently thick to ensure a long service life for ring 10, while maintaining a constant and high electrical conductivity.

For example, thickness (e) of membrane 30 is between 0.4 mm and 1 mm. Thus, thickness (b) of wear zone ZU is then between 0.5 mm and 3 mm.

In addition, as second end 32 of membrane 30 comprises wear zone ZU, using the notations in FIG. 2, thickness (c) of second end 32 is substantially equal to the sum of thickness (e) of the membrane and thickness (b) of wear zone ZU:

c=b+e.

Second frame 40 is for example securely mounted inside first frame 30, possibly by press-fitting or by crimping.

According to the embodiment presented in FIG. 1, first frame 20 and second frame 40 have an L shape and are nested one inside the other. Each of frames 20, 40 forms a cylindrical sleeve 21, 41 which extends along the direction of axis of rotation AX, then extends inwardly towards axis of rotation AX in a lateral annular flange 22, 42 that is perpendicular to the axis of rotation.

Cylindrical sleeve 21 of first frame 20 is thus adapted to be mounted by press-fitting into a hollow cylindrical housing 13 of fixed element 11.

Annular membrane 30 has an outside diameter adapted to be housed in cylindrical sleeve 21 of first frame 20, a first face 35 of first end 31 of membrane 30 resting against lateral annular flange 22 of first frame 20.

Cylindrical sleeve 41 of second frame 40 is then adapted to be mounted by press-fitting into the internal surface of cylindrical sleeve 21 of first frame 20, until lateral annular flange 42 of second frame 40 is pressing against a second face 36 of membrane 30 (at its first end 31), and therefore until it clamps first end 31 of membrane 30.

According to one embodiment, second frame 40 has a radial height (h) of lateral flange 42 that is greater than a radial height (g) of lateral flange 22 of first frame 20, such that lateral flange 42 extends further towards axis of rotation AX than does lateral flange 22 of first frame 20. Membrane 30 therefore has a second face 36 in contact with lateral flange 42 of second frame 40 along radial height (h), to an internal end 43 of second frame 40. Body 33 of membrane 30 is then unconstrained and extends in a curved manner along direction X of axis of rotation AX to second end 32 and wear zone ZU.

Internal end 43 of second frame 40 is optionally curved in direction X of axis of rotation AX. Membrane 30 is thus not affected by wear at internal end 43, and body 33 of membrane 30 more easily takes the desired curved shape, determined by calculation and/or testing. Indeed, this curved shape, the thickness, and the material of membrane 30 determine the radial force that the membrane exerts concentrically towards the axis of rotation and against rotating element 12. This radial force determines the quality of the contact of wear zone ZU against rotating element 12, and therefore the electrical conductivity of the ring and its ability to maintain this conductivity during operation, i.e. during the rotation of rotating element 12 and during the operating period.

According to a variant, second frame 40 is also capable of conducting an electric current. In this case, the path of the electric current may lie between membrane 30 and first frame 20 as above, but also between membrane 30 and second frame 40. Since second frame 40 is securely mounted to first frame 20, the other branch of the electric current traveling through second frame 40 then joins first frame 20. This arrangement makes it possible to increase the electrically conductive area of membrane 30 towards first frame 20, this electrically conductive area being substantially the sum of a first area A₂₂ of direct contact between membrane 30 and first frame 20 (or area of flange 22 of first frame 22) and a second area A₄₂ of contact between membrane 30 and second frame 40 (or area of flange 42 of the second frame).

First area A₂₂ is substantially equal to:

A₂₂=π·g·[D+2·h+h].

Second area A₄₂ is substantially equal to:

A₄₂=π·h·[D+2·d+2·h−g].

Since the contact between second frame 40 and first frame 20 is a metal-to-metal contact, its influence on conductivity is considered to be low, meaning that there is very low resistance to electrical conduction. Thus, due to the electrical conduction of second frame 40, the electrical conductivity of ring 10 may be reduced.

Furthermore, in the case of a second frame 40 that is capable of conducting electricity, a large radial height (h) makes it possible to obtain a large second area A₄₂ of contact between membrane 30 and second frame 40 (area of flange 42 of the second frame). The electrical conductivity of ring 10 may thus be increased.

According to one embodiment, radial height (h) of second frame 40 is at least twice the radial height (g) of first frame 30.

Radial height (g) of first frame 20 may be less than half of distance (Di) between the internal surface of fixed element 11 and the rotating element 12. Membrane 30 is then kept clamped, in the direction of axis of rotation AX, only along this radial height (g).

Radial height (h) of second frame 40 may be less than half of distance (Di) between the internal surface of fixed element 11 and the rotating element 12. In other words, radial height (h) of second frame 40 is less than the distance (d) between internal end 43 and rotating element 12. The size of second frame 40 is thus limited and its cost is also limited. Body 33 of membrane 30 retains a large curved zone all the way to wear zone ZU, to reduce the radial force and therefore the friction and wear on wear zone ZU.

According to one embodiment, first frame 20 and/or second frame 40 may comprise pins adapted to penetrate membrane 30 and secure it to said first and/or second frame. Thus, membrane 30 is mechanically secured to at least one or to both frames, and it is therefore fixedly held in ring 10.

According to one embodiment, membrane 30 may optionally be fixed to the first and/or second frame 20, 40. For example, membrane 30 is fixed to the first and/or second frame by adhesion.

According to one embodiment, membrane 30 may be fixed to the first and/or the second frame by using rivets distributed angularly over a circumference of membrane 30. The rivets pass through membrane 30 and at least one of the frames (the first and/or the second frame).

According to one embodiment, £ membrane 30 may comprise a conductive coating on its outer surface. Optionally, the entire outer surface of membrane 30 is covered with this conductive coating. Alternatively, predetermined portions of the outer surface of membrane 30 are covered with this conductive coating. For example, the conductive coating may be located only on wear zone ZU, contact surface 34, or first face 35 or second face 36, or a combination of these locations. The electrical conductivity of ring 10 may thus be improved.

According to one embodiment, membrane 30 may be formed of PTFE material. Preferably, this conductive material contains a conductive filler, such as carbon or the like.

According to one embodiment, body 33 of membrane 30 may comprise corrugations configured to adjust the desired value of the rigidity or flexibility of said membrane body. In particular, these corrugations are located between internal end 43 of second frame 40 and wear zone ZU.

Alternatively, body 33 of membrane 30 may comprise one or more thinner areas, for example located at one or more positions between internal end 43 of second frame 40 and wear zone ZU. This or these thinner areas are for example a reduction in thickness along a circumference or part of a circumference. This or these thinner areas may also be used to adjust the desired value of the rigidity or flexibility of said membrane body.

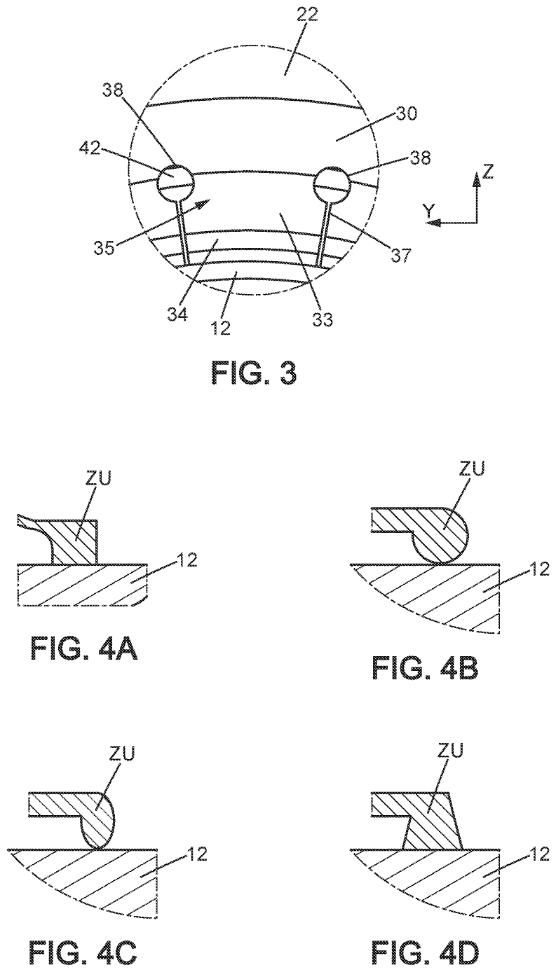

According to one embodiment presented in FIG. 3, membrane 30 may comprise slots 37 which extend radially and which separate body 33 of membrane 30 into angular sectors distributed along the circumference of membrane 30. Slots 37 are through-slots. Each slot 37 passes through membrane 30 between second end 32 and a radial point located near internal end 43 of second frame 40.

Because of these slots, membrane 30 is more flexible. The radial force is reduced. In addition, a smaller variation in the radial force is obtained in cases of non-circularity in rotating element 12 and/or non-coaxiality between fixed element 11 and rotating element 12. Membrane 30 more easily maintains the electrical contact between contact surface 34 and sliding surface 14 of rotating element 12. Electrical conductivity is increased and is more stable during operation.

Optionally, slots 37 terminate at said radial point in an open portion 38, as shown in FIG. 3. The open portion is for example a circular opening of predetermined diameter. This open portion prevents membrane 30 from tearing at the radial point.

According to various embodiments presented in FIG. 4A, FIG. 4B, FIG. 4C and FIG. 4D, the radial cross-section of wear zone ZU at second end 32 of membrane 30 may have various shapes. FIG. 4A shows a rectangular cross-section; FIG. 4B shows a circular cross-section; FIG. 4C shows an elliptical cross-section; and FIG. 4D shows a trapezoidal cross-section. These various shapes influence the radial force, the surface area of contact surface 34, and thus the conductivity and their evolution ver time. They may be selected based on tests and depending on the application. These shapes also influence the variation over time (during operation) of the conductivity of grounding ring 10.

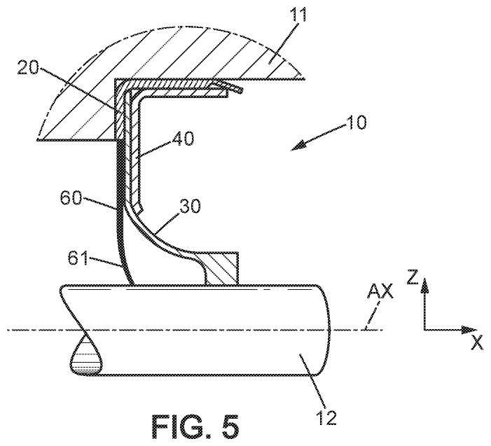

FIG. 5 illustrates an embodiment of grounding ring 10 which further comprises a sealing member 60. This sealing member is for example an elastic O-ring extending between a fixed first element 11 and rotating element 12. It may be connected directly or indirectly, in a sealed manner, to first frame 20 or to membrane 30 or to second frame 40. Sealing member 60 is for example made of an elastomer or rubber material. The sealing member may also comprise a lip 61 to ensure the seal is maintained on rotating element 12 and to limit the friction on rotating element 12.

Grounding ring 10 may comprise a single sealing member as shown in FIG. 5, located on one side or the other of membrane 30 along the direction of axis of rotation AX. Membrane 30 is thus protected against external contaminants coming from the side where the sealing member is located. Contaminant is understood to mean solid particles or fluids such as oil; these contaminants can affect the electrical conductivity of membrane 30 and therefore of grounding ring 10 due to their possible interaction with contact surface 34.

Alternatively, grounding ring 10 may comprise a sealing member 60 on each side of membrane 30 along the direction of axis of rotation AX. Thus, membrane 30 is protected on both sides against external contaminants.

Furthermore, sealing member(s) 60 may be made of a material that is also capable of conducting an electric current, i.e. having good electrical conductivity. For example, the sealing member includes a material comprising electrically conductive particles, or a material having an electrically conductive coating.

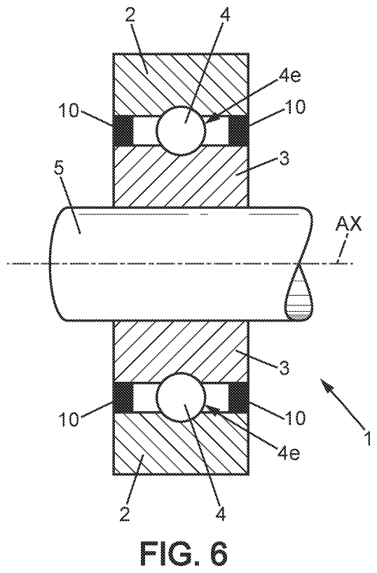

FIG. 6 shows a specific exemplary application of grounding ring 10 described above. This figure f shows a rolling bearing 1 comprising, on at least one side, a grounding ring 10 as described above for ensuring the transfer of electrical charges. The rolling bearing is for example a rolling bearing of a motor vehicle, and for example more particularly a rolling bearing of a motor vehicle wheel, as is represented in FIG. 5.

Rolling bearing 1 comprises in particular:
a fixed member 2,
a rotating member 3 that is rotated by a shaft 5 and to which is fixed for example a vehicle wheel, and
rolling bodies 4 arranged in the rolling space 4e formed between fixed member 2 and rotating member 3 in order to allow the relative rotation of rotating member 3 with respect to fixed member 2 about axis of rotation X, while taking up significant forces between the fixed member and the rotating member.

Fixed element 11 of ring 10 is either fixed member 2 directly, or is fixed to fixed member 2 of rolling bearing 1.

Rotating element 12 of ring 10 is either rotating member 3 directly, or is fixed to rotating member 3 of rolling bearing 1.

Rolling bodies 4 may be balls or cylinders or any other known type.

By means of grounding ring 10 of the present disclosure, rolling bearing 1 is able to transfer electrical charges to the fixed member and to the rotating member, without the charges passing through the rolling bodies as this could damage them. A vehicle equipped with such devices will thus be more durable.

### REFERENCE NUMBERS

10 Grounding ring
11 Fixed element
12 Rotating element
13 Housing
14 Sliding surface
20 First frame
21 Cylindrical sleeve
22 Lateral flange
30 Membrane
31 First end
32 Second end
33 Body
34 Contact surface
35 First face
36 Second face
37 Slots
38 Open portion
40 Second frame
41 Cylindrical sleeve
42 Lateral flange
43 Internal end
ZU Wear zone

1. Grounding ring intended to be mounted between a fixed element and a rotating element that is rotatable relative to the fixed element about an axis of rotation, the ring comprising:
a first frame that is annular and rigid, securely mounted to one among the fixed element and the rotating element,
a membrane that is annular and is made of an elastic material, extending between a first end in contact with the first frame and a second end in contact with the other among the fixed element and the rotating element, said membrane having a body between the first end and the second end,
a second frame that is annular and rigid, securely mounted to the first frame and adapted to clamp and fix the membrane between the first frame and the second frame, wherein
the first frame and the membrane are capable of conducting an electric current between the fixed element and the rotating element, and
said ring being characterized in that
the membrane comprises a wear zone at the second end, said wear zone being thicker than the body of the membrane, and the wear zone forming a contact surface configured to slide on a sliding surface of the other element while in contact therewith and to provide electrical conductivity between the fixed element and the rotating element.

2. Ring according to claim 1, wherein the wear zone of the membrane extends in the direction of the axis of rotation for a length that is greater than or equal to the thickness of the body of the membrane, the ring being in the mounted position between the fixed element and the rotating element.

3. Ring according to claim 1, wherein the wear zone has a greater thickness than the thickness of the body of the membrane.

4. Ring according to claim 1, wherein the wear zone has a mass that is configured to ensure contact between the contact surface and the sliding surface over a range of rotational speeds of the rotating element.

5. Ring according to claim 1, wherein the membrane is fixed to the second frame.

6. Ring according to claim 1, wherein the membrane comprises radial slots extending to the second frame and ending in an open portion.

7. Ring according to claim 1, wherein the membrane comprises an electrically conductive coating, said coating being at least on the contact surface of the wear zone.

8. Ring according to claim 1, wherein the membrane is formed from a PTFE material containing a conductive filler, such as carbon.

9. Ring according to claim 1, wherein the second frame is capable of conducting an electric current between the fixed element and the rotating element.

10. Ring according to claim 1, wherein the second frame has a radial height that is greater than a radial height of the first frame.

11. Ring according to claim 10, wherein the radial height of the second frame is at least twice the radial height of the first frame, and the radial height of the first frame is less than half the distance between the fixed element and the rotating element.

12. Ring according to claim 1, wherein the first frame or the second frame comprise pins adapted to penetrate the membrane and secure the membrane to the first or second frame.

13. Ring according to claim 1, wherein the second frame has an internal end that is curved towards the second end of the membrane, when the ring is in the mounted position.

14. Rolling bearing (1) comprising a grounding ring according to claim 1, and rolling bodies arranged within a rolling space to allow the relative rotation of the rotating element with respect to the fixed element, about the axis of rotation.
